(19) United States
(12) Patent Application Publication
(10) Pub. No.: US 2008/0111762 A1
(43) Pub. Date: May 15, 2008

(54) Wide Band-Width Antenna

(75) Inventors: Ching-Neng Kan, Taoyuan County (TW); Ching-Liang Lai, Taoyuan County (TW); Hsien-Chen Dai, Taoyuan County (TW); Yi-Hung Chang, Taoyuan County (TW)

Correspondence Address: WPAT, PC, 7225 BEVERLY ST., ANNANDALE, VA, 22003, US

(73) Assignee: KINSUN INDUSTRIES INC., Taoyuan County (TW)

(21) Appl. No.: 11/675,325

(22) Filed: Feb. 15, 2007

(30) Foreign Application Priority Data
Nov. 9, 2006 (TW) 095219780

(51) Int. Cl. H01Q 1/36; H01Q 1/12

(52) U.S. Cl. 343/878; 343/898

(57) ABSTRACT

A wide band-width antenna, comprising a copper tube in a main structure, wherein the copper tube is closed at one end and is provided with a screw thread at the other end inside the copper tube so as to be connected with a feed-in terminal.

### BACKGROUND OF THE INVENTION

1. Field of the Invention

The present invention generally relates to a wide band-width antenna and, more particularly, to an antenna using a copper tube in a main structure so as to improve the frequency response especially at low frequencies. The wide band-width antenna of the present invention has advantages in reliable transceiving, wider band-width, and compactness.

2. Description of the Prior Art

Antennas are widely used in wireless communication and dominate over other components in transceiving quality that is strongly determined by the structures of the antennas. In Taiwan Patent Publication No. M290618 “Compact antenna for digital broadcasting”, a first antenna and a second antenna are connected so as to minimize the antenna length. However, the first antenna and the second antenna are both spiral to have problems such as:

1) unreliability in signal receiving: the length of spiral antennas is often varied due to elastic fatique after long usage so that the frequency response is varied;

2) narrower band-width: spiral antennas are low-cost and easy to manufacture but the band-width is relatively narrower; and

3) limited length reduction: spiral antennas are designed to be longer for lower frequency applications.

In order to overcome the foregoing problems, there is need in providing a wide band-width antenna using a copper tube in a main structure so as to improve the frequency response especially at low frequencies.

### SUMMARY OF THE INVENTION

It is a primary object of the present invention to provide a wide band-width antenna using a copper tube instead of a spiral coil in a main structure so as to have advantages in reliable transceiving, wider band-width, and compactness.

It is a secondary object of the present invention to provide a wide band-width antenna that can be used in applications of a wide frequency range including digital video broadcasting (DVBT)/ultra high frequency (UHF) at 474˜860 MHz, global system for mobile communication (GSM) at 900, 1800 and 1900 MHz and ISM (industrial, scientific and medical) band at 2.4˜2.5 GHz and 5.8 GHz.

In order to achieve the foregoing objects, the present invention provides a wide band-width antenna, comprising a copper tube in a main structure, wherein the copper tube is closed at one end and is provided with a screw thread at the other end inside the copper tube so as to be connected with a feed-in terminal.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a side view of a wide band-width antenna according to the present invention; and

FIG. 2 is a cross-sectional view of the wide band-width antenna in FIG. 1.

### DETAILED DESCRIPTION OF THE PREFERRED EMBODIMENT

The present invention providing a wide band-width antenna can be exemplified by the preferred embodiment as described hereinafter.

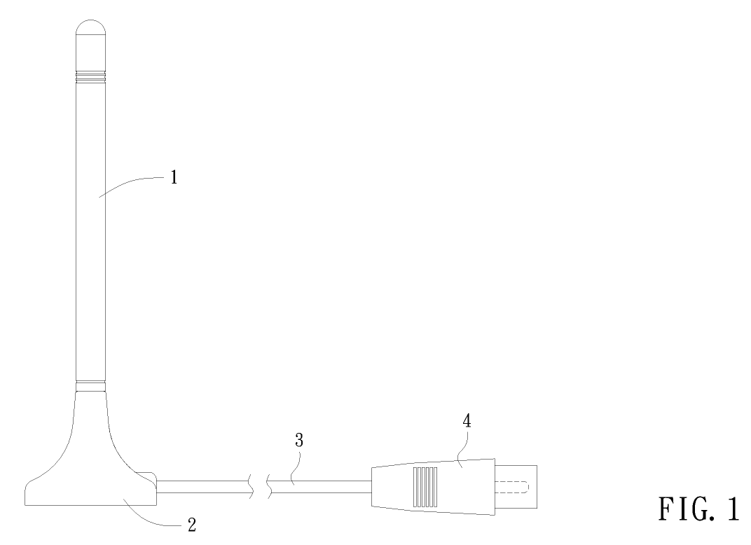

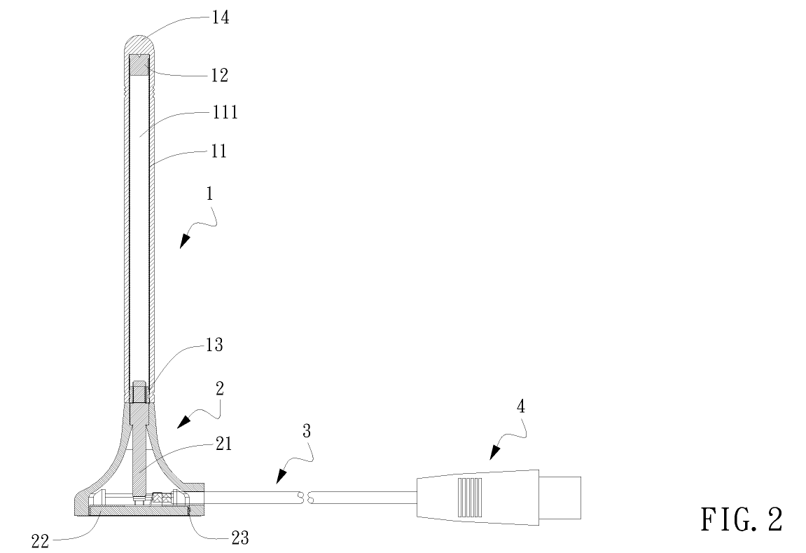

Please refer to FIG. 1 and FIG. 2 for a side view and a cross-sectional view, respectively, of a wide band-width antenna according to the present invention. The wide band-width antenna comprises a copper tube 11 in a main structure 1. In the present embodiment, the copper tube 11 has a hollow portion 111 for better antenna performance and lowered manufacturing cost. The copper tube 11 is closed at one end. In the present embodiment, the copper tube 11 is closed by a sealing lid 12 at one end and is covered by a plastic coating 14. The sealing lid 12 prevents the plastic coating 14 from flowing into the copper tube 11 during the coating process so that the antenna performance is avoided being affected. At the other end inside the copper tube 11, a screw thread is provided. In the present embodiment, the screw thread inside the copper tube 11 is provided by a screw nut 13 having the screw thread. The screw nut 13 is installed at the other end of the copper tube 11. The screw thread is used so that the copper tube 11 is connected with a feed-in terminal. The feed-in terminal comprises a base 2 and a wire 3 extended to the base 2. The base 2 is connected to the copper tube 11 using a screw bolt 21 screwed into the screw nut 13. The screw bolt 21 can be part of a medium for antenna signal transmission so as to deliver the antenna signal to the wire 3. The wire 3 extended to the base 2 further comprises a connector 4 for connection to an external wireless electronic appliance. The base 2 further comprises a magnet 22 and a housing 23.

Using the main structure 1 with a proper length of the wire 3, the wide band-width antenna 3 of the present invention can be used in applications of a wide frequency range including digital video broadcasting (DVBT)/ultra high frequency (UHF) at 474˜860 MHz, global system for mobile communication (GSM) at 900, 1800 and 1900 MHz and ISM (industrial, scientific and medical) band at 2.4˜2.5 GHz and 5.8 GHz.

With reference to the disclosure in FIG. 1 and FIG. 2, the wide band-width antenna of the present invention has advantages such as:

1) improved reliability in signal receiving: the length of the copper tube is fixed and thus the antenna is free of problems due to elastic fatique after long usage so that the frequency response is stable;

2) wider band-width: the copper tube is hollow inside and thus provides a wider band-width than the conventional spiral antenna; and

3) reduction in length of the antenna: the copper tube antenna has a wider band-width so that the length of the copper tube can be reduced; and

4) enhanced gain: the copper tube has a hollow portion for electromagnetic resonance to enhance the gain.

According to the above discussion, it is apparent that the present invention discloses a wide band-width antenna using a copper tube as its main structure so as to improve the frequency response especially at low frequencies. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A wide band-width antenna, comprising a copper tube in a main structure, wherein the copper tube is closed at one end and is provided with a screw thread at the other end inside the copper tube so as to be connected with a feed-in terminal.

2. The wide band-width antenna as recited in claim 1, wherein the copper tube has a hollow portion.

3. The wide band-width antenna as recited in claim 1, wherein the copper tube is closed at the one end by a sealing lid and is covered by a plastic coating, the sealing lid preventing the plastic coating from flowing into the copper tube during the coating process.

4. The wide band-width antenna as recited in claim 1, wherein the screw thread inside the copper tube is provided by a screw nut having the screw thread, the screw nut being installed at the other end of the copper tube.

5. The wide band-width antenna as recited in claim 1, wherein the feed-in terminal comprises a base and a wire extended to the base, the base being connected to the copper tube using a screw bolt screwed into the screw nut.

6. The wide band-width antenna as recited in claim 5, wherein the wire extended to the base further comprises a connector.

7. The wide band-width antenna as recited in claim 5, wherein the base further comprises a magnet and a housing.

8. The wide band-width antenna as recited in claim 1, wherein the wide band-width antenna can be used in applications of a wide frequency range including digital video broadcasting (DVBT)/ultra high frequency (UHF) at 474˜860 MHz, global system for mobile communication (GSM) at 900, 1800 and 1900 MHz and ISM (industrial, scientific and medical) band at 2.4˜2.5 GHz and 5.8 GHz.
